(19) United States
(12) Patent Application Publication
(10) Pub. No.: US 2014/0100890 A1
(43) Pub. Date: Apr. 10, 2014

(54) RISK MANAGEMENT SYSTEM AND METHOD FOR PROTECTING VIRTUAL ASSETS

(71) Applicant: Terrance Luciani, Monroe Township, NJ (US)

(72) Inventor: Terrance Luciani, Monroe Township, NJ (US)

(21) Appl. No.: 13/826,084

(22) Filed: Mar. 14, 2013

Related U.S. Application Data
(60) Provisional application No. 61/610,793, filed on Mar. 14, 2012.

(51) Int. Cl. G06Q 40/08

(52) U.S. Cl. CPC G06Q 40/08
USPC 705/4

(57) ABSTRACT

Disclosed is a system and method for protecting a user's virtual assets from various risks by providing risk-management products for virtual losses. Risks include situations resulting in a loss of virtual assets, for example but not limited to: account theft or hacking, fraud, breach of virtual contracts, and various in game events (such as a virtual hurricane destroying a virtual home).

### CROSS-REFERENCE TO RELATED APPLICATIONS

This application claims priority to U.S. Provisional Application Ser. No. 61/610,793, filed Mar. 14, 2012. The above application is incorporated herein by reference as if restated in full.

### BACKGROUND

In recent years, many new virtual worlds have been created and made available on the internet. Some of the virtual worlds are designed to provide a world of social interactions that is to some degree related to the real world, such as “Second Life.” Some are fantasy game virtual worlds where the participants are engaged in co-operative or competitive game play, such as World of Warcraft, Talisman Online, Guild Wars, and DC Universe Online. Many of these games are “Massive Multi Player Online” role playing games or video games that are played using either a network of a video game server and at least two video game clients or a peer-to-peer network of at least two video game clients. Players create characters that may interact with other characters in a virtual world that is stored on the video game server and/or the video game clients. Often, though not necessarily, these games have no ultimate winner, but instead attempt to create an enjoyable playing environment and a strong player community.

The virtual world users can, for example, explore, meet other virtual world residents, socialize, participate in individual or group activities, create and trade items of virtual property, participate in quests or missions. An example of virtual property can include vehicles or mounts used for transportation, objects used as furniture, artwork, and real estate. Conditions of scarcity, specialization, and comparative advantage may create an economic system with properties similar to those seen in contemporary capitalist economies.

Further, the user characters themselves are virtual items. The value of a character may depend on character attributes or character skills Characters attributes are any quality, trait, feature or characteristic a particular character can have that is stored in the corresponding character account. Character attributes may include, but are not limited to: a character score, a character level/rank, attack score, defense score, sight score, magic score, weapon score, the physical appearance of a character, a synthetic voice, virtual money, virtual help points or credits, the ability to join groups of other players, and/or a relationship with another character. Character skills are game attributes inherent or acquired by a user's character during game play such as, but not limited to: the ability to cast certain spells, foretell the future, read minds, use certain weapons, cook, hunt, find herbs, assemble herbs into potions, mine, assemble objects into other objects, fly, and/or enchant other player characters.

Virtual services may be offered for sale, for example, mission or quest help, building help, businesses management, entertainment, and other personal services. Because a virtual world may allow real estate transactions in virtual land, there may be an active virtual real estate market. Because the sale of property and services is often a source of revenue for virtual world creators, an online marketplace may act as a retailer of the virtual world property and services.

Players may also create virtual contracts between themselves. For example, agreements to provide or exchange game attributes (such as items, services or skills) to one another. In some instances, once a player-to-player contract is established, the game server or peer-to-peer network automatically distributes acquired game attributes between the player characters based on the contract conditions. Such virtual contracts are described further in U.S. Pat. No. 7,966,239, herein incorporated by reference.

Obtaining the virtual property (including characters) and services described above can be extremely time consuming and difficult. For example, certain rare items may require hundreds of hours of game-play to acquire. Accordingly, virtual property and services have real world value based on, for example, their scarcity and difficulty to obtain. Online auction sites such as eBay show many such items, such as World of Warcraft weapons, for sale in real world currency. For example, a user may choose to purchase a virtual game sword on eBay for $500 as opposed to investing 50 hours in the virtual world to earn enough virtual currency to purchase such a sword. Systems for converting virtual world currency to real world currency and vice versa are described further in U.S. Patent Publication No. 20080255957, herein incorporated by reference.

There remains a need for a system and method of protecting a user's virtual assets from various risks by providing real world compensation for virtual losses. Risks include situations resulting in a loss of virtual assets, for example but not limited to: account theft or hacking, fraud, breach of virtual contracts, and various in game events (such as a virtual hurricane destroying a virtual home). Account theft or hacking, for instance, has been a growing problem as hackers can sometimes auction a character's virtual property for hundreds or thousands of dollars.

### DESCRIPTION

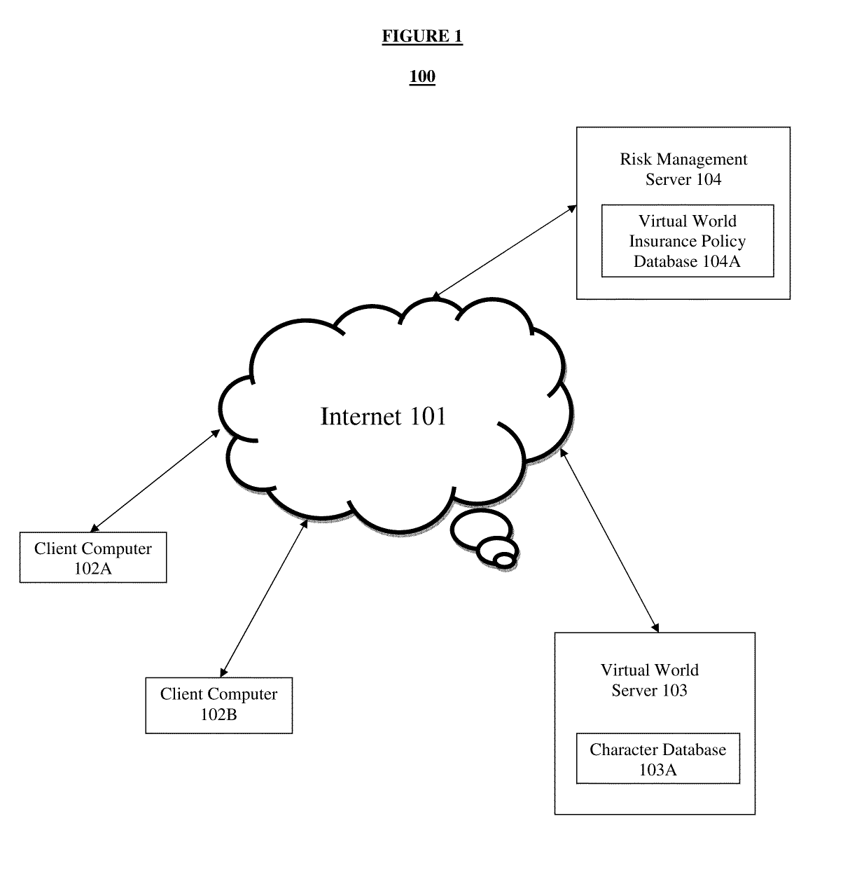

FIG. 1 illustrates an embodiment of the system of the present disclosure for providing a user of a virtual world protection against virtual losses. System 100 includes Client Computer 102A and Client Computer 102B, each containing client software (not shown) for accessing a virtual world by communicating with Virtual World Server 103 via Internet 101. Client Computer 102A is used by User A (not shown) and associated with Character A (not shown). Client Computer 102B is used by User B (not shown) and associated with Character B (not shown). Characters A and B are able to interact with each other via Virtual World Server 103. Virtual World Server 103 contains a Character Database 103A which includes information about each character and the virtual world, such as items possessed, property owned, skills, various character attributes, and in game events (such as virtual natural disasters). Upon acquiring a rare and/or valuable item, User A may wish to insure the item. User A may use Client Computer 102A to access Risk Management Server 104 via Internet 101, and may purchase Insurance or other risk management products for that item.

Users may insure an entire character account or specific components of that account (an item, property, skill, etc). Users may also choose what types of losses they wish to insure against (for example, any loss, only account theft, only virtual natural disasters, etc). Once processed, the policy information is then stored in Virtual World Insurance Policy Database 104A. A virtual loss may be reported to Risk Management Server 104 by User A, or automatically by the client software on Client Computer A or Virtual World Server 103. In a preferred embodiment, if the loss is reported by User A, Risk Management Server 104 confirms the loss with Virtual World Server 103 via Internet 101.

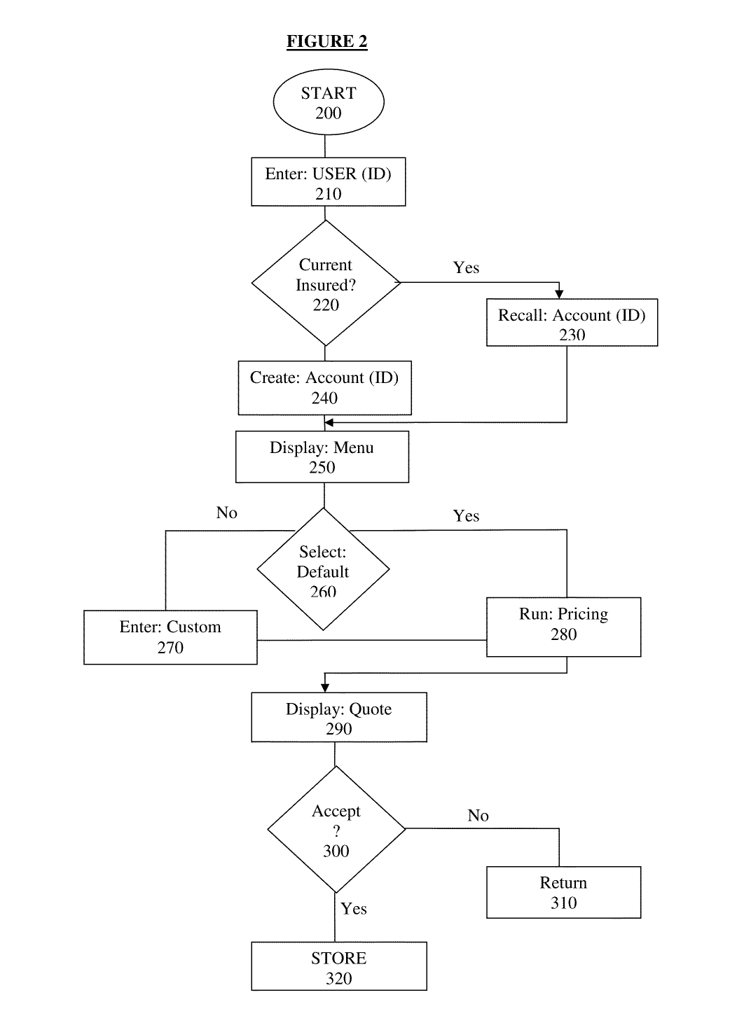

FIG. 2 describes the process flow in one embodiment of the invention. The process starts at step 200, and then continues to step 210 where a user enters her user ID (or name). The system determines if the user is currently insured, step 220, and if so, recalls the user's account, step 230. If the user is not currently insured, the system creates a new account, step 240. After the user account is accessed or created, a menu is displayed, step 250. The user may select default insurance options, step 260. For example, a default option may be to insure an entire virtual world character account against account theft or hacking, fraud, breach of virtual contracts, and in game natural disasters. Alternatively, the user may enter custom insurance options, step 270. For example, if none of the default options include coverage for only the user's rare sword against only account hacking, the user may create a custom risk management package to meet those needs. At step 280, the system will compute pricing based on the parameters selected by the user at step 260 or step 270, as well as other user and virtual world character account specific information. The quote for insurance coverage is then provided and/or displayed to the user, step 290. The user may accept or reject the risk management package, step 300. If the user accepts the package, the information is stored in the system, step 320, otherwise, the user is returned to the menu, step 310.

The invention described above is operational with general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

Components of the inventive computer system may include, but are not limited to, a processing unit, a system memory, and a system bus that couples various system components including the system memory to the processing unit. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system typically includes a variety of non-transitory computer-readable media. Computer-readable media can be any available media that can be accessed by the computer and includes both volatile and nonvolatile media, and removable and non-removable media. By way of example, and not limitation, computer-readable media may comprise computer storage media and communication media. Computer storage media may store information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The computer system may operate in a networked environment using logical connections to one or more remote computers. The remote computer may be a personal computer, a server, a router, a network PC, a peer device or other common network node, and typically includes many or all of the elements described above relative to the computer. The logical connections depicted in include one or more local area networks (LAN) and one or more wide area networks (WAN), but may also include other networks. Such networking environments are commonplace in offices, enterprise-wide computer networks, intranets and the Internet.

For ease of exposition, not every step or element of the present invention is described herein as part of software or computer system, but those skilled in the art will recognize that each step or element may have a corresponding computer system or software component. Such computer systems and/or software components are therefore enabled by describing their corresponding steps or elements (that is, their functionality), and are within the scope of the present invention. In addition, various steps and/or elements of the present invention may be stored in a non-transitory storage medium, and selectively executed by a processor.

The foregoing components of the present invention described as making up the various elements of the invention are intended to be illustrative and not restrictive. Many suitable components that would perform the same or similar functions as the components described are intended to be embraced within the scope of the invention. Such other components can include, for example, components developed after the development of the present invention.

What is claimed:

1. A system for generating a risk management policy for protecting virtual assets, comprising:
a data processor selectively programmed to provide a user with risk management policy options for protecting one or more virtual assets;
a network connection to receive a user's input, wherein said input comprises information related to said one or more virtual assets and a selection of said risk management policy options;
an electronic database for storing said user's input, including selected risk management policy; and
said data processor further programmed such that if there is a loss related to said one or more virtual assets, payment will be made to said user based on said stored selected risk management policy.
